(19) United States
(12) Patent Application Publication
(10) Pub. No.: US 2007/0002341 A1
(43) Pub. Date: Jan. 4, 2007

(54) Image Forming Device

(75) Inventor: Atushi KATO, Sunto-gun (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/427,245

(22) Filed: Jun. 28, 2006

(30) Foreign Application Priority Data
Jun. 30, 2005 (JP) 2005-193030

(51) Int. Cl. G06K 15/10

(52) U.S. Cl. 358/1.5; 358/1.9; 358/402

(57) ABSTRACT

An image forming device comprises a printer having a color mode and a monochromatic mode and a display unit which displays an operation screen. The image forming device holds identification information of a division to which a user belongs, the identification information being input by the user, in a management mode to manage the number of pages printed in a color mode by the printer for each division to which each user belongs. In a case where the operation mode of the printer is changed to the color mode, the image forming device displays the operation screen to accept a printing request in the color mode, when the identification information is held, and displays an input guidance to urge that the identification information of the division to which the user belongs be input, when the identification information is not held.

### CROSS-REFERENCE TO RELATED APPLICATIONS

This application is based upon and claims the benefit of priority from prior Japanese Patent Application No. 2005-193030, filed Jun. 30, 2005, the entire contents of which are incorporated herein by reference.

### BACKGROUND OF THE INVENTION

1. Field of the Invention

The present invention relates to an image forming device such as a digital multifunction machine having a division management function of managing use results such as the number of pages printed for each division to which each user belongs, and a method of managing the image forming device.

2. Description of the Related Art

Heretofore, among image forming devices such as a digital multifunction machine, there is a device having a function which manages the number of printed pages. In an image forming device such as the digital multifunction machine or a printer having a network communicating function, there is assumed an operation mode in which the device is utilized by a large number of users. Among such image forming devices, there is a device having a function referred to as a division management function which manages the number of pages printed for each management unit referred to as a division. In this division management function, a division counter set for each division counts the number of the pages printed for each division.

### BRIEF SUMMARY OF THE INVENTION

In one aspect of this invention, an object is to provide an image forming device capable of appropriately managing use results in accordance with user's request and improving user's operability, and a method of managing the image forming device.

An image forming device as one aspect of this invention has: a display unit which displays an operation screen; a printer having a first operation mode and a second operation mode which is different from the first operation mode; a management unit having a management mode to manage the number of pages printed in the first operation mode by the printer for each division to which a user belongs; an input unit which inputs identification information of the division to which the user belongs; a memory which holds the identification information input by the input unit; and a display control unit which displays, in the display unit, the operation screen to accept a printing request in the first operation mode, when the identification information is held in the memory, and which displays, in the display unit, an input guidance to urge that the identification information of the division to which the user belongs be input by the input unit, when the identification information is not held in the memory, in a case where the operation mode of the printer is requested to be changed to the first operation mode.

A method of managing an image forming device as another aspect of the present invention is a method for use in an image forming device including a printer having a first operation mode and a second operation mode which is different from the first operation mode and a display unit which displays an operation screen, and the method: executes a management mode to manage the number of pages printed in the first operation mode by the printer for each division to which each user belongs; inputs identification information of the division to which the user belongs; holds the input identification information; changes the operation mode of the printer to the first operation mode, when the identification information is held, in a case where the operation mode of the printer is requested to be changed to the first operation mode; displays the operation screen of the first operation mode to accept a printing request in the first operation mode, in a case where the operation mode of the printer is changed to the first operation mode; and displays an input guidance of the identification information to urge that the identification information of the division to which the user belongs be input, when the identification information is not held, in a case where the operation mode of the printer is requested to be changed to the first operation mode.

An image forming device as still another aspect of this invention has: display means for displaying an operation screen; image forming means having a first operation mode and a second operation mode which is different from the first operation mode; management means having a management mode to manage the number of pages printed in the first operation mode by the image forming means for each division to which a user belongs; input means for inputting identification information of the division to which the user belongs; storage means for holding the identification information input by the input means; and display control means for displaying, in the display means, the operation screen to accept a printing request in the first operation mode, when the identification information is held in the storage means, and displaying, in the display means, an input guidance to urge that the identification information of the division to which the user belongs be input by the input means, when the identification information is not held in the memory, in a case where the operation mode of the image forming means is requested to be changed to the first operation mode.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram schematically showing a constitution example of an image forming system in an embodiment of the present invention;

FIG. 2 is a block diagram schematically showing a constitution example of a digital multifunction machine;

FIG. 3 is a diagram showing a constitution example of an operation panel;

FIG. 4 is a flowchart schematically showing a printing control with respect to a printing job in the digital multifunction machine;

FIG. 5 is a flowchart showing a processing example of division code check;

FIG. 6 is a flowchart showing a display control in a state in which a color management function is valid;

FIG. 7 is a diagram showing a display example of a division code input screen in a display section of the operation panel;

FIG. 8 is a diagram showing a display example of a scanning screen in the display section of the operation panel;

FIG. 9 is a diagram showing a display example of a photocopying screen (photocopying initial screen) in an initial state in the display section of the operation panel; and

FIG. 10 is a diagram showing a display example of the photocopying screen in a state in which full color is selected in the display section of the operation panel.

### DETAILED DESCRIPTION OF THE INVENTION

An embodiment for carrying out this invention will be described hereinafter with reference to the drawing.

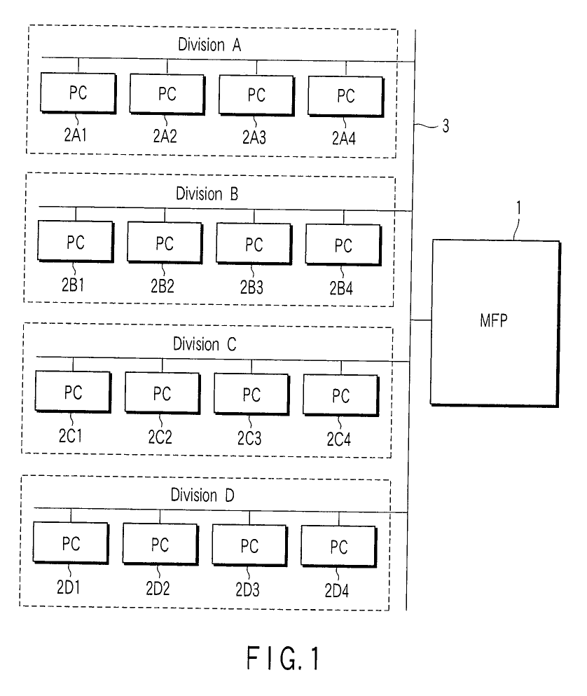

FIG. 1 is a diagram showing a schematic constitution of an image forming system in the embodiment of this invention.

As shown in FIG. 1, in this image forming system, a digital multifunction machine (multifunction peripheral: MFP) 1 as an image forming device is connected to a plurality of personal computers (PCs) 2 (2A1 to 2A4, 2B1 to 2B4, 2C1 to 2C4 and 2D1 to 2D4) by a network 3 such as a local area network (LAN).

The MFP 1 mainly has a printer function, a scanner function, a photocopying function, a facsimile transmitting and receiving function and the like. The MFP 1 has a function which processes a color image and a function which processes a monochromatic image. That is, the MFP 1 has: a color scanning function which chromatically reads an image of a draft; a monochromatic scanning function which monochromatically reads the image of the draft; a color printing function which forms a color image on an image forming medium; and a monochromatic printing function which forms a monochromatic image on the image forming medium.

Accordingly, the MFP 1 realizes color photocopy and monochromatic photocopy as the photocopying function, and realizes color print and monochromatic print as the printer (network printing) function. It is to be noted that as the facsimile receiving function, the monochromatic print is performed.

Each PC 2 is constituted of a main body having a network interface (not shown), a display unit (not shown), an operation unit (not shown) and the like. The PC 2 has a function which requests the MFP 1 to print the image via the network 3. In the function which requests the MFP 1 to print the image, each PC 2 transmits color image data or monochromatic image data as printing image data.

For example, when the PC 2 requests the MFP 1 to print the color image data, the peripheral performs the color print based on the color image data received by a network printing function. When the PC 2 requests the MFP 1 to print the monochromatic image data, the peripheral performs the monochromatic print based on the monochromatic image data received by the network printing function.

Moreover, it is assumed that the PCs 2 (2A1 to 2A4, 2B1 to 2B4, 2C1 to 2C4 and 2D1 to 2D4) are assigned to the users divided into groups referred to as divisions, respectively. Here, the division refers to the group to which each user having each PC 2 assigned thereto belongs. In an organization such as a company, it is assumed that a department, a section or the like as a place to which each of a plurality of users belongs corresponds to the division.

In a constitution example shown in FIG. 1, it is indicated that a plurality of PCs 2A1 to 2A4 are used by the users who belong to a division A. In FIG. 1, it is also indicated that a plurality of PCs 2B1 to 2B4 are used by the users who belong to a division B. It is further indicated in FIG. 1 that a plurality of PCs 2C1 to 2C4 are used by the users who belong to a division C. It is further indicated in FIG. 1 that a plurality of PCs 2D1 to 2D4 are used by the users who belong to a division D.

Next, there will be described a constitution of a control system of the MFP 1.

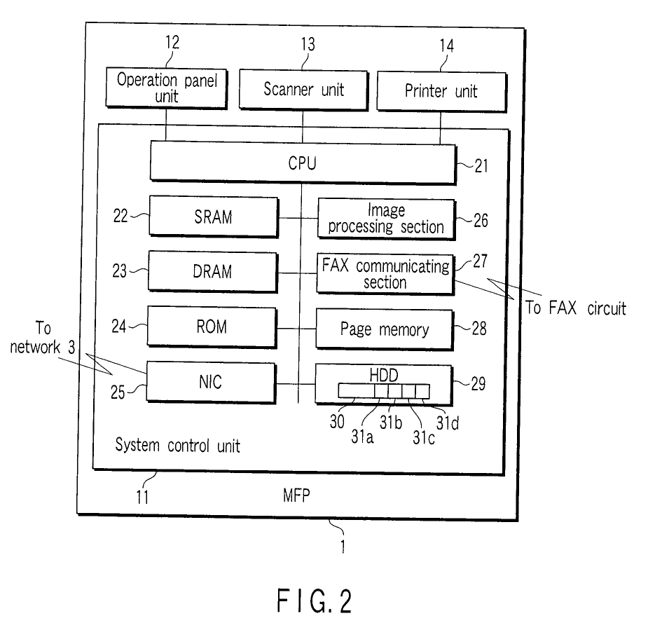

FIG. 2 is a block diagram showing a constitution example of the control system of the MFP 1.

As shown in FIG. 2, this MFP 1 is constituted of a system control unit 11, an operation panel 12, a scanner unit 13, a printer unit 14 and the like.

The system control unit 11 controls the whole MFP 1. The system control unit 11 is connected to the operation panel 12, the scanner unit 13, the printer unit 14 and the like. Accordingly, the system control unit 11 accepts an operation instruction input into the operation panel 12, controls the scanner unit 13, or controls the printer unit 14. In addition to the function which controls the scanner unit 13 and the printer unit 14, the system control unit 11 also has functions which perform various types of processing such as network communication control, facsimile transmission and reception, division (or user) authentication, data management, image judgment and image correction.

The operation panel 12 is a user interface. The operation panel 12 is constituted of hardware keys (not shown), a display device (not shown) containing a touch panel and the like. The operation panel 12 displays an operation guidance and the like, and an operation instruction is input. Settings of various types of functions, setting information and the like are input by the operation panel 12. There will be described later in detail a constitution example of the operation panel 12 and a display control with respect to the display unit of the operation panel 12.

The scanner unit 13 converts the draft image into image data. The scanner unit 13 converts the draft image into chromatic or monochromatic digital image data. The scanner unit 13 is constituted of: a scanning section (not shown) which optically scans a draft face; a photoelectric converting section (not shown) such as a CCD line sensor which converts, into an electric signal, reflected light from the draft face optically scanned by the scanning section and the like. The scanner unit 13 supplies the digital image data as the read draft image to the system control unit 11.

The printer unit 14 forms the image on the image forming medium. The printer unit 14 has: a color printing function which forms a color image on the image forming medium based on the color image data; and a monochromatic printing function which forms a monochromatic image on the image forming medium based on the monochromatic image data. The printer unit 14 is constituted of: a conveying section (not shown) which conveys the image forming medium; an image forming section (not shown) which forms the color image or the monochromatic image on the image forming medium conveyed by the conveying section and the like. The printer unit 14 prints the image data of each page on the image forming medium based on the control performed by the system control unit 11.

Moreover, as shown in FIG. 2, the system control unit 11 is constituted of: a central processing unit (CPU) 21; a static random access memory (SRAM) 22; a dynamic random access memory (DRAM) 23; a read only memory (ROM) 24; a network communicating section 25; an image processing section 26; a facsimile (FAX) communicating section 27; a page memory 28; a hard disk drive (HDD) 29 and the like.

The CPU 21 controls the whole system control unit 11. The CPU 21 operates based on a control program to perform various types of processing. The CPU 21 is connected to the operation panel 12, the scanner unit 13, the printer unit 14 and the like. The CPU 21 is also provided with a timer 21a which counts an elapsed time or the like.

The SRAM 22 is backed up by a battery (not shown), and used as a memory which stores system setting information and the like. Data for changing and the like are stored in the SRAM 22. For example, a counter value of the number of the pages printed by a division management function described later is counted up in a counter set in the SRAM 22.

The DRAM 23 is a memory which temporarily stores data for operation or stores data to be referred to. The DRAM 23 is used as a main memory. In a case where, for example, the system setting information and the like are referred to from the outside, the information stored in the DRAM 23 is referred to.

The ROM 24 is a nonvolatile memory. In the ROM 24, there are stored, for example, the control program, control data and the like for controlling the MFP 1. The network communicating section 25 controls data communication via the network 3. The network communicating section 25 is constituted of a network interface card (NIC) to be connected to the network 3 and the like. In the network communicating section 25, a network printer function receives a request for printing the printing image data and the like from each PC 2 via the network 3.

The image processing section 26 subjects the image data to various types of image processing. The image processing section 26 is constituted of an image processing circuit and the like. The image processing section 26 performs image processing such as correction, compression or expansion of the image data. The facsimile communicating section 27 is an interface which transmits and receives facsimile data.

For example, facsimile reception processing is realized by monochromatically printing, by the printer unit 14, facsimile data received by the facsimile communicating section 27, and facsimile transmission processing is realized by converting the draft image data read by the scanner unit 13 into facsimile data, and transferring the data from the facsimile communicating section 27 to a destination.

The page memory 28 is a memory having at least a storage region to develop the image data for one page to be printed by the printer unit 14. The page memory 28 is controlled by a page memory controller (not shown). For example, in a case where the printer unit 14 performs the print processing, in the page memory 28, there is developed (stored) the color image data or the monochromatic image data of each page to be printed by the printer unit 14.

The HDD 29 is a large-capacity storage device. The HDD 29 is also used as a memory for backup of various types of data, and various types of setting data or management data are stored. In the HDD 29, there is stored data received via the network 3, the image data read by the scanner unit 13 or the like, if necessary. In the present embodiment, in the HDD 29, there is stored division management information such as a division code corresponding to a division constituting a management object of the division management function described later.

Moreover, the HDD 29 is provided with: a division undefined counter 30 in which the corresponding division is not defined; a division counter 31 (31a, 31b, 31c and 31d) for each division constituting the management object of the division management function as the division management means and the like. The division undefined counter 30 is a counter which is not associated with any specific division (a counter in which the division is not defined). The division counters 31a, 31b, 31c and 31d are counters associated with the divisions as the management objects, respectively, by the division management function.

It is to be noted that in the constitution example shown in FIG. 2, there is assumed a case where, as shown in FIG. 1, the divisions A, B, C and D are set as the divisions constituting the management objects of the MFP 1. Therefore, in the MFP 1, the divisions A, B, C and D are set as the management objects of the division management function described later. In this case, in the HDD 29, there are stored division management information such as the division codes corresponding to the divisions A, B, C and D, and there are arranged the division counters 31a, 31b, 31c and 31d associated with the divisions A, B, C and D as the divisions constituting the management objects. That is, the division counter 31 is set for each division constituting the management object of the division management function of the MFP 1.

Next, a constitution of the operation panel 12 will be described.

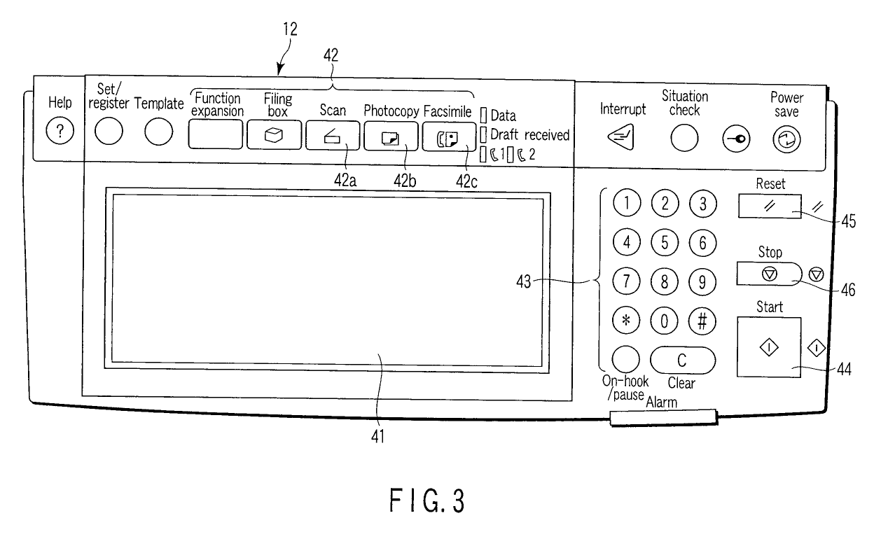

FIG. 3 is an appearance diagram showing the whole constitution of the operation panel 12.

As shown in FIG. 3, the operation panel 12 is provided with a display section 41, function setting keys 42, numeric keys 43, a start key 44, a reset key 45, a stop key 46 and the like.

The display section 41 is constituted of a liquid crystal display unit containing a touch panel. In the display section 41, there are displayed various operation screens operable by the touch panel. There will be described later in detail a display example of the operation screen to be displayed in the display section 41. The function setting keys 42 are hardware keys for selecting various functions. As the function setting keys 42, there are arranged, for example, a scanning function selection key 42a for selecting a scanning function, a photocopying function selection key 42b for selecting a photocopying function, an FAX function selection key 43c for selecting a facsimile function and the like.

The numeric keys 43 are hardware keys for inputting numerals. The numeric keys 43 are used in inputting information such as the number of sheets to be photocopied and a division code. The start key 44 is a hardware key for instructing start of an operation. For example, in the photocopying function, a photocopying operation is started in response to an instruction of the start key 44. The reset key 45 is a hardware key for instructing reset of set contents or the like. For example, setting input into the touch panel of the display section 41 or the like is reset in response to the reset key. The stop key 46 is a hardware key for instructing the MFP to discontinue an operation being executed. For example, when the stop key 46 is indicated during the photocopying operation of the MFP, the photocopying operation is discontinued.

Moreover, in addition to the above various keys, the operation panel 12 shown in FIG. 3 is provided with: a help (HELP) key which instructs display of a user guidance; a set/register key which instructs execution of setting or registering; a template key for selecting a template as defect registered beforehand; an interrupt key which requests interruption of the operation; a situation check key for checking a state of the MFP; a lock key for performing a security setting or the like; a power saving key for switching a power saving operation mode which reduces a power consumption and a usual operation mode; an on-hook/pause key for setting an on-hook state as a phone function; a clear key for clearing the numerals input by the numeric keys; an alarm display unit for notifying an abnormality in the MFP and the like.

Next, there will be described the color print and the monochromatic print in the MFP 1 constituted as described above.

Here, it is assumed that the MFP 1 manages various types of processing such as a series of photocopy processing, scan processing and print processing every unit referred to as a job. For example, the photocopy processing executed in accordance with one instruction is managed as a photocopying job. The photocopy processing includes: the scan processing to read a draft image; and the print processing to print the image read by the scan processing. Therefore, the photocopying job may be managed by a scanning job and a printing job.

Furthermore, the MFP 1 has a monochromatic photocopying mode, a color (full color) photocopying mode and an auto color mode as the above photocopying function. The monochromatic photocopying mode is a mode to read the draft image as the monochromatic image, and monochromatically print the read monochromatic image on the image forming medium. The color photocopying mode is a mode to read the draft image as the color image, and chromatically print the read color image on the image forming medium. In the auto color mode, it is judged whether the draft image is chromatic or monochromatic, and color photocopy (color scan and color print) or monochromatic photocopy (color scan and monochromatic print) is executed in accordance with the judgment result.

Moreover, the MFP 1 as the network printing function selectively executes the color print or the monochromatic print in accordance with printing image data received together with a printing request from each PC 2. The MFP 1 as the network printing function receives one printing request to manage, as a printing job, print processing in response to the request.

Next, there will be described the division management function of the MFP 1.

The division management function of the MFP 1 is a function of division management means for managing use results (the number of printed pages, etc.) of the MFP 1 for each division. For example, in the image forming system shown in FIG. 1, the division management function of the MFP 1 manages the number of the pages printed for each division or limits the number of printable pages for each division. It is to be noted that the division management function is set to be valid or invalid by an operation of the operation panel 12.

Moreover, in the HDD 29 or the like, there is stored division management information (information such as the division code and the division counter) on the division as a management object of the division management function. That is, the division to be managed by the division management function is set beforehand as the division management information associated with the division code for identifying the division. As the division management information, there is also defined (set) the division counter 31 associated with the division code. The division counter 31 is a counter which counts the number of the pages printed for each division. In a case where an upper limit of the number of the pages printed for each division is set, the upper limit of the number of the printed pages is also stored as a part of the division management information in the HDD 29. It is to be noted that in a case where the color management function described later is valid, the upper limit of the number of only the chromatically printed pages may be set as a part of the division management information in the HDD 29.

For example, in the image forming system shown in FIG. 1, the divisions constituting the management objects are the divisions A, B, C and D. In this case, unique division codes are set to the divisions (divisions A, B, C and D), respectively. In a case where the thus set division management function is valid, the MFP 1 identifies the division to which the user belongs based on the division code designated by the user.

For example, in a case where the photocopying function is utilized in a state in which the division management function is valid, the user inputs the division code by the operation panel 12 of the MFP 1. When the user inputs the division code by the operation panel 12, the MFP 1 authenticates the user's division based on the division code input by the user and the division code as the division management information set beforehand. Accordingly, when the user's division is identified, the MFP 1 is brought into a state in which the photocopy is possible in response to the user's operation. When the user operates the operation panel 12 to request desired photocopy in this state, the MFP 1 executes the requested photocopy processing, and manages the number of the pages printed as photocopies, as use results of the identified division.

Moreover, in a case where the network printing function is utilized in a state in which the division management function is valid, the user operates each PC 2 to designate the printing image data and the division code of the division to which the user belongs. In this case, the PC 2 transmits a printing request including the printing image data and the division code to the MFP 1 via the network 3. On receiving the printing request from the PC 2 via the network 3, the MFP 1 authenticates the user's division based on the division code included in the received printing request and the division code as the division management information set beforehand. Accordingly, when the user's division is identified, the MFP 1 executes the print processing based on the received printing image data, and manages the number of the pages printed in the print processing as the use results of the identified division.

Next, there will be described a color management (management for color only) function to be performed in a case where the division management function is valid.

The MFP 1 has the color management (management for color only) function which manages only the number of the chromatically printed pages for each division, when the division management function is valid. This color management function is a function of limiting management means for counting only the number of the chromatically printed pages for each division in the division management function. In other words, the color management function is a function (a function which does not manage the monochromatic print for each division) which does not count the number of monochromatically printed pages in the division counter.

In the MFP 1 having a state in which the above color management function is valid, the number of the monochromatically printed pages is not regarded as the management object, and only the number of the chromatically printed pages is managed. That is, in a state in which the color management function is valid, the number of the chromatically printed pages is counted in the division counter 31 disposed for each division, and the number of the monochromatically printed pages is counted by the division undefined counter 30. As a result, when the color management function is valid, the monochromatic print is limitlessly performed even in a state in which the division is not identified.

In general, in the monochromatic print, consumption of a developer such as toner, a photosensitive member or the like is small, and cost is small as compared with the color print. The monochromatic print is utilized in performing miscellaneous daily printings in many cases. In such situation, there is a case where any restriction is not imposed on the monochromatic print, and only the color print is requested to be managed. In such case, the above color management function is required. According to the color management function, the monochromatic print can limitlessly be performed, and only the use results of the color print can be managed.

Next, there will be described a printing control in a case where the printing job is generated by the photocopying function, the network printing function or the like in the MFP 1 constituted as described above.

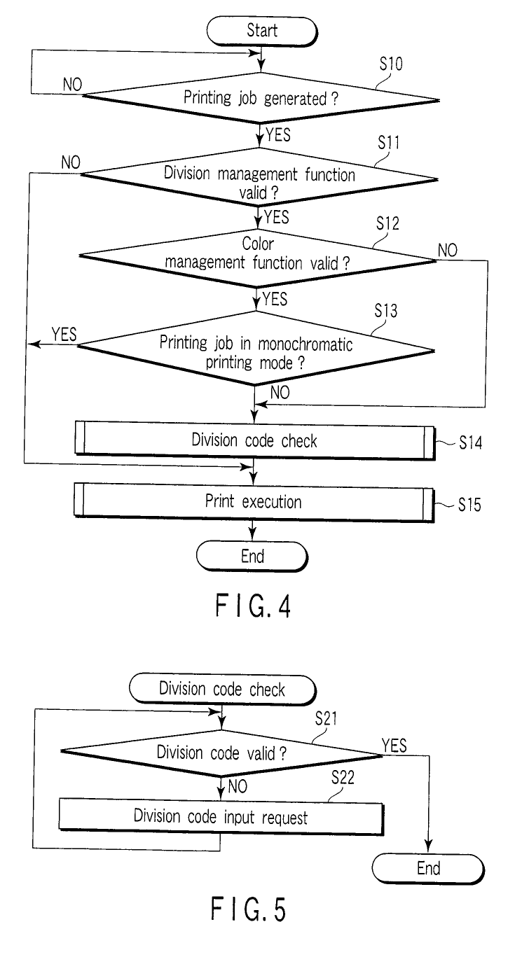

FIG. 4 is a flowchart schematically showing the printing control in a case where the printing job is generated.

In the MFP 1, in a usual operation state, there is accepted a printing job generated by the photocopying function, the network printing function, the facsimile function or the like (step S10). In this state, for example, in a case where the printing request is received from the PC 2 as the network printing function, a case where the draft image is read by the scanner as the photocopying function, a case where facsimile data is received as the facsimile function or a case where a request for list output is received, one printing job is generated in the MFP 1.

When such printing job is generated (step S10, YES), the CPU 21 of the system control unit 11 judges whether or not the division management function is valid (step S11). In a case where this judgment is that the division management function is invalid (step S11, NO), the CPU 21 allows the printer unit 14 to execute the print processing with respect to the printing job (step S15). That is, in a case where the division management function is invalid, the printing job is other than the management object of the division management function. Therefore, the system control unit 11 does not count the number of the pages printed as the printing job.

Moreover, in a case where the above judgment is that the division management function is valid (step S11, YES), the CPU 21 judges whether or not the color management function is valid (step S12). In a case where this judgment is that the color management function is valid, the CPU 21 judges whether or not the printing job has a monochromatic printing mode (step S13).

In a case where this judgment is that the printing job has the monochromatic printing mode (step S13, YES), the CPU 21 executes the print processing in the monochromatic printing mode with respect to the printing job (step S15). That is, in a state in which both of the division management function and the color management function are valid, the CPU 21 executes the print as the printing job without checking any division code.

This indicates that if both of the division management function and the color management function are valid, the input of the division code by the user is not required. In this case, the printer unit 14 performs the monochromatic print in a state in which both of the division management function and the color management function are valid. Therefore, in the system control unit 11, the number of the printed pages (the number of the monochromatically printed pages) during the printing operation in the printer unit 14 is counted up by the division undefined counter 30.

Moreover, in a case where that the judgment is that the color management function is invalid, that is, even in a case where it is judged that the division management function is valid and the color management function is invalid (step S12, NO), the CPU 21 checks the division code (step S14). The above division code check is division code identification processing to determine the division of the user who has requested the printing job. When the division is determined by the above division code check, the CPU 21 allows the printer unit 14 to execute the print processing with respect to the printing job (step S15).

In this case, the division management function is valid, and the color management function is invalid. Therefore, in the system control unit 11, the division counter 31 is counted up in accordance with the number (the number of the chromatically and monochromatically printed pages) of the printed pages to be counted during the printing operation of the printer unit 14.

Furthermore, in a case where the above judgment is that the mode is not the monochromatic printing mode (i.e., the mode is the full color mode or the auto color mode) (step S13, NO), the CPU 21 checks the division code for identifying the division of the user who has requested the printing job (step S14). When the division is determined by this division code check, the CPU 21 allows the printer unit 14 to execute the print processing with respect to the printing job (step S15).

In this case, both of the division management function and the color management function are valid. Therefore, as to the number of the printed pages to be counted during the printing operation in the printer unit 14, the system control unit 11 counts up the number of the chromatically printed pages in the division counter 31, and counts up the number of the monochromatically printed pages by the division undefined counter 30.

FIG. 5 is a flowchart showing a processing example of the division code check. As shown in FIG. 5, in this division code check, the CPU 21 judges whether or not the division code designated by the user is valid (step S21). In a case where this judgment is that the division code designated by the user is not valid or that any division code is not designated by the user (step S21, NO), the CPU 21 requests the user who has requested the printing job to input the division code (step S22).

As this request to the user for the input of the division code, the CPU 21 allows, for example, the operation panel 12 to display that the division code be input. In a case where the above judgment is that the division code designated by the user is valid (step S21, YES), the CPU 21 determines the division code as the division of the printing job, and ends the division code check.

Next, there will be described set processing of the color management function.

As described above, in the color management function, the number of the pages printed in the monochromatic mode is not counted in the division counter 31, and is counted by the division undefined counter 30. Therefore, in a case where the color management function is valid, the print or the photocopy in the monochromatic mode can limitlessly be executed, even unless the division is determined. In the present embodiment, in a case where the color management function is valid, that is, the color management function is brought into a valid state, the photocopying mode (or the printing mode) is forcibly brought into the monochromatic mode in the initial state. Accordingly, the photocopy or the print in the monochromatic mode which can limitlessly be executed can be instructed by less operation procedures, and operability can be improved.

Moreover, an operation for setting the color management function is executed using the operation panel 12. The operation for setting the color management function is usually performed by a manager. For example, when the manager instructs setting registration in the operation panel 12, a setting registration screen is displayed. When the manager instructs the setting of the manager in this setting registration screen, a manager setting screen is displayed in the display section 41.

When the manager instructs setting of the device in this manager setting screen, a device setting screen is displayed in the display section 41. In this device setting screen, the setting of the color management function is displayed as a selectable menu item. When the setting of this color management function is instructed, in the display section 41 there is displayed a setting screen for setting whether or not the color management function is set to be valid or invalid. In this display state, the manager instructs that the color management function be set to be valid.

When it is instructed that the color management function be set to be valid in this manner, the CPU 21 sets an initial value (initial value of the color mode) to be monochromatic, the initial value being displayed as the color mode in the initial state of the screen displayed in the display section 41. In this set processing of the color management function, a mode other than the monochromatic mode cannot be selected as the initial value of the color mode. Therefore, in the set processing of the color management function, the color management function is brought into the valid state, and the initial value of the color mode is set to be monochromatic.

Next, there will be described a display control of the display section 41 of the operation panel 12.

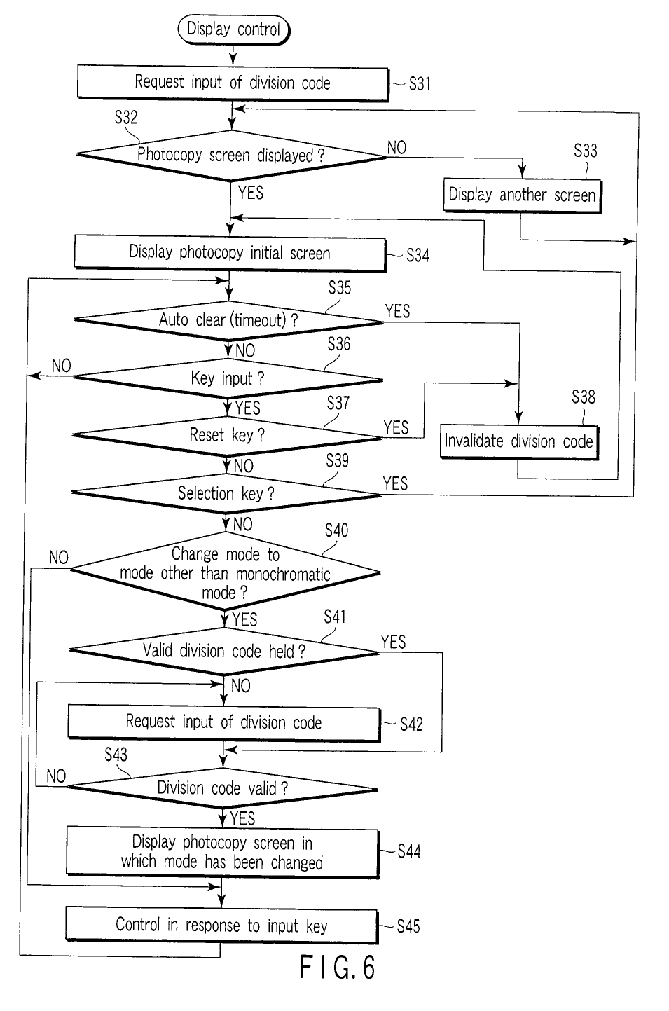

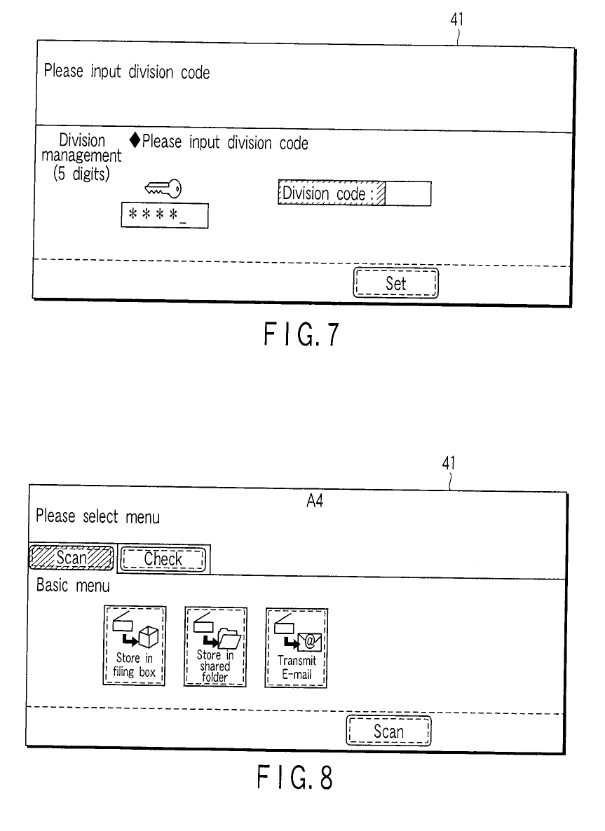

FIG. 6 is a flowchart showing the display control of the display section 41. FIGS. 7 to 12 are diagrams showing display examples of the display section 41. It is to be noted that in the following description, there is assumed a case where both of the division management function and the color management function are valid.

First, it is assumed that a screen (hereinafter referred to as the division code input screen) to request the input of the division code is displayed in the display section 41 of the operation panel 12 (step S31). In this division code input screen, a display column for inputting the division code is displayed together with a division code input guidance. In a state in which this division code input screen is displayed, the CPU 21 waits for the input of the division code, the function selection key 42 or the like.

FIG. 7 is a diagram showing a display example of the division code input screen. As shown in FIG. 7, in the division code input screen, there are displayed a division code input column and a set key together with guidance indicating “please input the division code”. When the division code is input into such division code input screen, the user inputs the division code by use of the numeric keys 43 or the like. In a case where the numeric keys 43 are input in a state in which the division code input screen is displayed, the CPU 21 displays information in the division code input column in response to the input key. In the example of the division code input screen shown in FIG. 7, a mark is displayed in accordance with the number of digits input into the division code display column.

It is to be noted that input numerals may be displayed in the division code display column. Furthermore, the user who has input the division code in the division code input screen indicates the set key. When the set key of the division code input screen is indicated, the CPU 21 holds the input division code in a memory such as the SRAM 22.

Moreover, in a case where any of the function selection keys 42 is input in a state in which the division code input screen is displayed, the CPU 21 switches the division code input screen displayed in the display section 41 to a setting screen of a function corresponding to the input function selection key 42. In this case, the CPU 21 holds the division code set in the division code input screen.

In a case where the user inputs the function selection key 42 other than the photocopying function selection key 42b in a state in which the division code input screen is displayed (step S32, NO), the CPU 21 switches the operation mode of the MFP 1 to the operation mode of the function corresponding to the selected key, and displays, in the display section 41, the setting screen of the function corresponding to the selected key (step S33). In this case, the CPU 21 holds the division code set in the division code input screen. That is, the input division code is held in a memory such as the SRAM 22.

For example, in a case where the user inputs the scanning function selection key 42a in a state in which the division code input screen is displayed (step S32, NO), the CPU 21 switches the operation mode of the MFP 1 to an operation mode of the scanning function, and displays a scanning function setting screen (scanning screen) in the display section 41 (step S33). When the user inputs the FAX function selection key 42c (step S32, NO), the CPU 21 switches the operation mode of the MFP 1 to an operation mode of the FAX function, and displays an FAX function setting screen (FAX screen) in the display section 41.

FIG. 8 is a diagram showing a display example of the scanning screen. That is, in a case where the user inputs the scanning function selection key 42a in a state in which the division code input screen is displayed as shown in FIG. 7, the CPU 21 displays the scanning screen shown in FIG. 8 in the display section 41. In the scanning screen shown in FIG. 8, various executable scanning functions are displayed in icons as a scanning function menu.

Moreover, in a case where the user inputs the photocopying function selection key 42b in a state in which the division code input screen is displayed or a screen of the function other than the photocopying function is displayed (step S32, YES), the CPU 21 switches the operation mode of the MFP 1 to the operation mode of the photocopying function, and displays the photocopying screen in the display section 41 (step S34).

In the processing of this step S34, the input division code remains to be held in a memory such as the SRAM 22 without being cancelled. That is, when the function is switched by the function selection key 42 (e.g., switching of the scanning function, the photocopying function, the FAX function or the like), the division code held in a memory such as the SRAM 22 is not cancelled.

To switch to such photocopying function, the photocopying screen (photocopying initial screen) in the initial state is displayed in the display section 41. Here, it is assumed that the color management function is valid. Therefore, there is displayed the initial value set in the above set processing of the color management function. That is, in a case where the color management function is valid, the initial value of the color mode is set to be monochromatic. Therefore, the CPU 21 displays in the display section 41 the photocopying screen in a state in which the monochromatic mode is selected as the photocopying initial screen.

FIG. 9 is a diagram showing a display example of the photocopying initial screen. In the photocopying initial screen shown in FIG. 9, there are displayed a full color key 41a, a monochromatic key 41b, an auto color key 41c and the like for selecting the color mode of the photocopying function, and the monochromatic key 41b is displayed in a selected state (reverse display). When the monochromatic key 41b is reverse-displayed, it is indicated that the present color mode is the monochromatic mode.

In a state in which such photocopying initial screen is displayed, the CPU 21 waits for the input of the instruction into various types of hardware keys of the operation panel 12 and various keys selectable in the touch panel displayed in the photocopying screen. In this state, the CPU 21 counts an elapsed time in a state in which there is not any input in the timer 21a.

When such no-input state continues for a predetermined or more time, the CPU 21 judges timeout, and resets the set contents displayed in the photocopying screen (step S35). In this case, accompanying the resetting of the set contents, the CPU 21 invalidates the division code held in the SRAM 22 (step S38), and returns to the step S34. IN this case, the CPU 21 displays in the display section 41 the photocopying initial screen shown in FIG. 9.

Moreover, when there is a key input in the photocopying screen displayed in the display section 41 (step S36, YES), the CPU 21 distinguishes the input key. Accordingly, when the input key is the reset key (step S37, YES), accompanying the resetting of the set contents, the CPU 21 invalidates the division code held in the SRAM 22 (step S38), and returns to the step S34. In this case, the CPU 21 displays the photocopying initial screen shown in FIG. 9 in the display section 41.

Furthermore, when any of the function selection keys 42 is input (step S39, YES), the CPU 21 returns to the step S32, and displays in the display section 41 the screen of the function corresponding to the input key. In a case where the color mode of the photocopying screen displayed in the display section 41 is instructed to be changed to a mode other than the monochromatic mode, that is, in a case where the full color key 41a or the auto color key 41c is selected in the photocopying screen in a state in which the monochromatic key 41b is selected (step S40, YES), the CPU 21 changes the color mode from the monochromatic mode to the full color mode or the auto color mode (steps S41 to S45).

In a case where the full color key 41a or the auto color key 41c is selected in the photocopying screen in a state in which the monochromatic key 41b is selected (step S40, YES), the CPU 21 judges whether or not the valid division code is held in a memory such as the SRAM 22 (step S41). In a case where this judgment is that the valid division code is not held (step S41, NO), the CPU 21 displays in the display section 41 the division code input screen to urge the input of the division code (step S42). Accordingly, in a case where the division code is input, the CPU 21 confirms validity of the division code input in the division code input screen (step S43).

Moreover, in a case where the above judgment is that the valid division code is held (step S41, YES), the CPU 21 confirms the validity of the division code held in a memory such as the SRAM 22 (step S43). In a case where the validity of the division code is thus confirmed (step S43, YES), the CPU 21 displays in the display section 41 the photocopying screen in which the full color or the auto color is brought into the selected state (step S44).

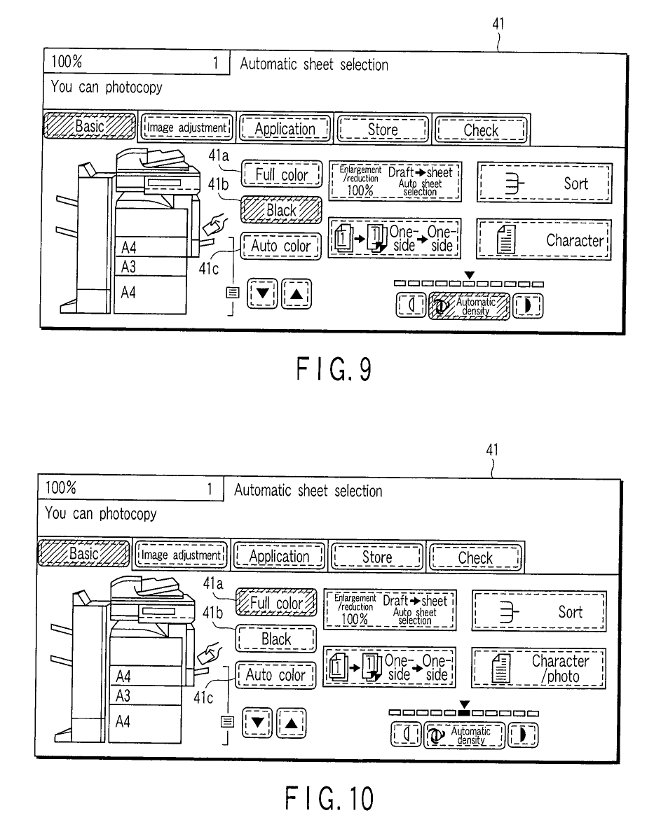

FIG. 10 is a diagram showing a display example of the photocopying screen in which the full color is brought into the selected state (the color mode is the full color mode). In the photocopying screen shown in FIG. 10, there are displayed the full color key 41a, the monochromatic key 41b, the auto color key 41c and the like for selecting the color mode of the photocopying function, and the full color key 41a is displayed in a selected state (reverse display). When the full color key 41a is reverse-displayed, it is indicated that the present color mode is the monochromatic mode.

That is, in a case where the user inputs the full color key 41a in the photocopying screen in which the monochromatic key 41b is selected as in the photocopying initial screen or the like, when the division code is held, and the validity of the held division code is confirmed, the CPU 21 brings the full color key 41a into the selected state without displaying any division code input screen. Accordingly, when the division code is once input, the user does not have to input again the division code every time the color mode is changed.

In the above display state of the photocopying screen, the CPU 21 performs a control in response to the input into each key (step S45). As shown in, for example, FIG. 10, in a case where the start key 44 is input in a state in which the full color key 41a is brought into the selected state, the CPU 21 performs the photocopy processing in the full color mode. Even in a case where another key is input in a state in which the monochromatic key is selected in the photocopying screen displayed in the display section 41, the CPU 21 performs the control in response to the input key (step S45). As shown in, for example, FIG. 9, in a case where the start key 44 is input in a state in which the monochromatic key 41b is selected, the CPU 21 performs the photocopy processing in the monochromatic mode.

As described above, in the MFP of the present embodiment, in a case where both of the division management function and the color management function are valid, the division code input into the division code input screen is held, even if the function or the like is switched. In a case where the division code shifts to a necessary mode, when the division code is held, the MFP specifies the division based on the held division code. If any division code is not held, the MFP displays the division code input screen, and urges the input of the division code.

In consequence, in a state in which both of the division management function and the color management function are valid in the MFP, any division code does not have to be input every time various types of functions are switched. As a result, user's operability can be improved.

Furthermore, in a case where the reset key is indicated or the screen is automatically cleared and reset, the held division code is invalidated in the MFP. Therefore, even in an operation mode in which the MFP is used by a large number of users, each user can be urged to input a correct division code.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An image forming device comprising:
a display unit which displays an operation screen;
a printer having a first operation mode and a second operation mode which is different from the first operation mode;
a management unit having a management mode to manage the number of pages printed in the first operation mode by the printer for each division to which a user belongs;
an input unit which inputs identification information of the division to which the user belongs;
a memory which holds the identification information input by the input unit; and
a display control unit which displays, in the display unit, the operation screen to accept a printing request in the first operation mode, when the identification information is held in the memory, and which displays, in the display unit, an input guidance to urge that the identification information of the division to which the user belongs be input by the input unit, when the identification information is not held in the memory, in a case where the operation mode of the printer is requested to be changed to the first operation mode.

2. The image forming device according to claim 1, wherein the first operation mode is a color mode in which a color image is printed, and the second operation mode is a monochromatic mode in which a monochromatic image is printed.

3. The image forming device according to claim 1, further comprising:
an invalidation unit which invalidates the identification information held in the memory, in a case where set contents in the image forming device are reset.

4. The image forming device according to claim 3, further comprising:
an operation key which instructs processing including the resetting of the set contents in the image forming device,
the invalidation unit invalidating the identification information held in the memory in response to an input into the operation key.

5. The image forming device according to claim 3, further comprising:
various operation keys which instruct various types of processing; and
a timer to count a time when there continues a state in which there is not any input into the operation key,
the invalidation unit invalidating the identification information held in the memory, in a case where the time counted by the timer reaches a predetermined time.

6. The image forming device according to claim 1, further comprising:
a judgment unit which judges whether or not the identification information held in the memory is valid, in a case where the operation mode of the printer is requested to be changed to the first operation mode,
the display control unit displaying in the display unit the operation screen to accept an operation in the first operation mode, in a case where the judgment unit judges that the identification information held in the memory is valid,
the display control unit displaying in the display unit an input screen to urge that the identification information of the division to which the user belongs be input in the input unit, in a case where the judgment unit judges that the identification information held in the memory is not valid.

7. A method of managing an image forming device including: a printer having a first operation mode and a second operation mode which is different from the first operation mode; and a display unit which displays an operation screen, the method comprising:
executing a management mode to manage the number of pages printed in the first operation mode by the printer for each division to which each user belongs;
inputting identification information of the division to which the user belongs;
holding the input identification information;
changing the operation mode of the printer to the first operation mode, when the identification information is held, in a case where the operation mode of the printer is requested to be changed to the first operation mode;
displaying the operation screen of the first operation mode to accept a printing request in the first operation mode, in a case where the operation mode of the printer is changed to the first operation mode; and
displaying an input guidance of the identification information to urge that the identification information of the division to which the user belongs be input, when the identification information is not held, in a case where the operation mode of the printer is requested to be changed to the first operation mode.

8. The method of managing the image forming device according to claim 7, wherein the first operation mode is a color mode in which a color image is printed, and the second operation mode is a monochromatic mode in which a monochromatic image is printed.

9. The method of managing the image forming device according to claim 7, further comprising:
invalidating the held identification information, in a case where set contents in the image forming device are reset.

10. The method of managing the image forming device according to claim 9, wherein the invalidating of the identification information includes:
invalidating the held identification information, in a case where there is instructed processing including the resetting of the set contents in the image forming device.

11. The method of managing the image forming device according to claim 9, further comprising:
counting a time when there continues a state in which there is not any input into various operation keys to instruct various types of processing,
the invalidating of the identification information including: invalidating the held identification information, in a case where the counted time when there continues the state in which there is not any input into the operation keys reaches a predetermined time.

12. The method of managing the image forming device according to claim 7, further comprising:
judging whether or not the held identification information is valid, in a case where the operation mode of the printer is requested to be changed to the first operation mode,
the displaying of the operation screen of the first operation mode including: displaying the operation screen of the first operation mode, in a case where the judgment is that the held identification information held is valid,
the displaying of the input guidance of the identification information including: displaying an input screen to urge that the identification information of the division to which the user belongs be input, in a case where the judgment is that the held identification information is not valid.

13. An image forming device comprising:
display means for displaying an operation screen;
image forming means having a first operation mode and a second operation mode which is different from the first operation mode;
management means having a management mode to manage the number of pages printed in the first operation mode by the image forming means for each division to which a user belongs;
input means for inputting identification information of the division to which the user belongs;
storage means for holding the identification information input by the input means; and
display control means for displaying, in the display means, the operation screen to accept a printing request in the first operation mode, when the identification information is held in the storage means, and displaying, in the display means, an input guidance to urge that the identification information of the division to which the user belongs be input by the input means, when the identification information is not held in the memory, in a case where the operation mode of the image forming means is requested to be changed to the first operation mode.

14. The image forming device according to claim 13, wherein the first operation mode is a color mode in which a color image is printed, and the second operation mode is a monochromatic mode in which a monochromatic image is printed.

15. The image forming device according to claim 13, further comprising:
invalidation means for invalidating the identification information held in the storage means, in a case where set contents in the image forming device are reset.

16. The image forming device according to claim 15, further comprising:
operation means for instructing processing including the resetting of the set contents in the image forming device,
the invalidation means invalidating the identification information held in the storage means in response to an input into the operation means.

17. The image forming device according to claim 15, further comprising:
various operation means for instructing various types of processing; and
timing means for counting a time when there continues a state in which there is not any input into the operation means,
the invalidation means invalidating the identification information held in the storage means, in a case where the time counted by the timing means reaches a predetermined time.

18. The image forming device according to claim 13, further comprising:
judgment means for judging whether or not the identification information held in the storage means is valid, in a case where the operation mode of the image forming means is requested to be changed to the first operation mode,
the display control means displaying in the display means the operation screen to accept an operation in the first operation mode, in a case where the judgment means judges that the identification information held in the storage means is valid,
the display control means displaying in the display means an input screen to urge that the identification information of the division to which the user belongs be input in the input means, in a case where the judgment means judges that the identification information held in the storage means is not valid.
